(19) United States
(12) Patent Application Publication
(10) Pub. No.: US 2008/0032897 A1
(43) Pub. Date: Feb. 7, 2008

(54) Methods of screening for inhibitors of autoinhibited proteins

(76) Inventor: Jonathon CHERNOFF, Jenkintown, PA (US)

Correspondence Address: JAGTIANI + GUTTAG, 10363-A DEMOCRACY LANE, FAIRFAX, VA, 22030, US

(21) Appl. No.: 11/662,186

(22) PCT Filed: Sep. 9, 2005
(86) PCT No.: PCT/US05/32195

§ 371 Date: Jul. 19, 2007

Related U.S. Application Data
(60) Provisional application No. 60/608,105, filed on Sep. 9, 2004.

(51) Int. Cl. C40B 40/10; C40B 20/04

(52) U.S. Cl. 506/4; 506/18

(57) ABSTRACT

Methods for obtaining highly target-specific inhibitory compounds are disclosed. These inhibitory compounds provide for the preservation of a native, non-activated form of an autoinhibited molecule, such as a protein or enzyme. The inhibitory compounds are further described as essentially free of inhibitory activity for non-native forms of an autoinhibited molecule of interest. By way of example, such autoinhibited molecules of interest include proteins and enzymes, such as the p-21-activated kinases (Paks) and the Rho-activated proteins. The inhibitory compounds act by binding to a distinct, autoinhibitory domain of an autoinhibited molecule (protein), and thereby stabilize an autoinhibited conformation of the molecule (protein). Preparations, including pharmaceutical preparations, compromising a composition enriched for the inhibitory compounds are also disclosed.

### CROSS-REFERENCE TO RELATED APPLICATIONS

This application claims priority to U.S. provisional application U.S. Ser. No. 60/608,105, entitled “Methods of Screening for Inhibitors of Autoinhibited Proteins,” filed Sep. 9, 2004, the entire disclosure and contents of which are hereby incorporated herein by reference.

### GOVERNMENT INTEREST STATEMENT

The United States Government has rights in this invention pursuant to Contract No. ROI GM-54168 and CORE Grant No. CA-06927 with the National Institutes of Health.

### BACKGROUND

1. Field of the Invention

The present invention relates to the field of pharmacologically active inhibitors of autoinhibited molecules. The invention also relates to the field of screening methods for identifying inhibitors of autoinhibited molecules, and particularly, autoinhibited proteins.

2. Related Art

Among the most utilized assays for high throughput screening are assays that measure kinase activity. These assays are simple, inexpensive, robust, and sensitive to the measured parameter, yet insensitive to compound solvent or biophysical properties of the compounds, such as fluorescence. However, such an assay has not been developed for use in the screening and identification of sufficiently selective inhibitors of many classes of kinases, including the clinically important class of kinases known as the p21-activated kinases (Paks).

Paks comprise a family of six highly related cytosolic kinases in humans that can be subdivided by sequence similarly into two subgroups. The kinase activity of the group A Paks (Pak1-3) is dramatically enhanced by binding to the small (p21) GTPases Rac and Cdc42, hence the name “Pak.” By contrast, the catalytic activity of the more distantly related group B Paks (Pak4-6) does not appear to be similarly regulated by GTPase binding.

The p21-activated kinase (Pak) inhibitors have been described for both therapeutic and research purposes. For example, the Paks have garnered much attention as possible therapeutic targets in tumorigenesis.¹⁻³ Paks have also been proposed to play an important role in actin cytoskeletal structure and cell morphogenesis,⁴⁻⁸ polarization,⁹⁻¹¹ cell motility,¹²⁻¹⁴ neuronal development,¹⁵⁻¹⁹ transformation and tumor invasiveness.²⁰⁻²²

Most pharmaceutical companies seek inhibitors of enzymes that directly bind the enzyme's catalytic site.³⁶ To date, no sufficiently specific Pak inhibitors have been identified using this approach. One reason for this, among others, may exist in the observation that kinase domains are remarkably conserved across diverse kinase families and consequently, many chemical kinase inhibitors inhibit multiple kinases.

To date, no compounds have been identified that target the Pak inhibitor domain, PID, and discriminate between group A and group B Paks sufficiently to allow functional discrimination of these two highly related subfamilies. The kinase domains of group A and group B Paks are more highly conserved than the N-terminal regions,⁴¹ thus current strategies targeting the kinase domain are more likely to inhibit both subgroups, rather than the specific subgroup desired. One of the events that has been characterized in the regulation of Pak is that the PID of Pak binds an alpha helix within the kinase domain (KD) to mediate autoinhibition.³²

One particular inhibitor of the autoinhibited protein, Pak, selected using conventional selection methods is CEP-1347. CEP-1347 is an indolocarbazole related to staurosporine. It has been reported to inhibit Pak at low micromolar concentrations, but is at least an order of magnitude more potent against the mixed-lineage kinases (MLKs).⁴³⁻⁴⁴ Other Pak kinase inhibitors (e.g., staurosporine) are even less selective.

Another important autoinhibited protein is Wiskott-Aldrich syndrome protein (WASP). The WASP family of proteins consists of two highly homologous members, the hematopoietic cell-specific WASP protein and the ubiquitously expressed version, N-WASP. Both WASP and N-WASP participate in signaling pathways regulating the actin cytoskeleton and share a similar domain structure.³⁷⁻³⁸ The N-terminus of WASP binds Cdc42 and contains an autoinhibitory segment called the p21-binding domain (PBD). The C-terminus of WASP consists of a domain that mediates activation of the effector of WASP, the Arp2/3 complex. Regulation of WASP is mediated in part by an autoinhibitory, intramolecular interaction between the PBD and an alpha helix within the C-terminal Arp2/3 complex-activating domain. Analysis of the NMR structure of the autoinhibited core of WASP has revealed that activation of WASP must involve a conformational change to release the C-terminal alpha helix from masking by the PBD.³⁵

Subsequent crystallization of Pak revealed that the PID of Pak shares a similar conformational fold with the PBD of WASP.³² Whereas the WASP PBD mediates autoinhibition of the C-terminal Arp2/3 complex-activating segment by binding to a C-terminal alpha helix, the PID of Pak binds a structurally analogous alpha helix within the kinase domain to mediate autoinhibition.

Using a high-throughput screening method of a signaling pathway regulating actin polymerization in cytoplasmic extracts, without any allosteric criteria, two structurally distinct, chemical inhibitors of N-WASP; 187-1, a cyclic peptide³⁹ and an N-alkylated dibromocarbazole (wiskostatin) were identified.⁴⁰ The NMR structure of WASP bound to wiskostatin revealed that wiskostatin bound exclusively to the PBD in its autoinhibited conformation. Biophysical experiments further demonstrated that wiskostatin stabilizes the autoinhibited fold of the PBD.⁴⁰

The NMR structure of the autoinhibited core of WASP demonstrated that activation of WASP involves a conformational change that releases the C-terminal alpha helix from masking by the PBD.⁴⁷

Crystallization of Pak revealed that the Pak inhibitor domain (PID) of Pak shares a similar fold with that observed for the PBD of WASP.⁴⁸ Thus, these functionally distinct proteins, WASP and Pak, appear to utilize a similar autoregulatory domain to mediate distinct downstream functions in response to Cdc42.

Despite various observations of the conformational behavior and activation of these and other important autoinhibited proteins, no screening methods have emerged that utilize these unique conformational behaviors and selective activational criteria for screening and identifying selective allosteric inhibitors of autoinhibited proteins.

A need continues to exist for more selective and specific inhibitors of allosterically regulated autoinhibited molecules, such as proteins, as well as methods for screening for such inhibitory compounds. Such a method would preferably identify inhibitory molecules that provide for selective inhibition of an autoinhibited molecule, such as a protein, that acts through an allosteric mechanism, and select against molecules that inhibit via interaction with non-allosteric and/or non-autoinhibitory domains of the autoinhibited protein, compound and/or molecule.

### SUMMARY

The present invention is directed to overcoming the above-mentioned and other challenges related to the use and regulation of autoinhibited proteins, and particularly to methods useful for identifying and screening for compounds capable of allosterically inhibiting and/or conserving the native, non-activated state, of a wide range of autoinhibited proteins, molecules and/or compounds. By way of example, one such important group of autoinhibited proteins is the p21-activated kinases (Paks).

The present inventors' understanding of the association of a drug with the active and autoinhibited conformations of allosterically modulated proteins, such as Paks, has led to the development and optimization of a uniquely designed screening method based primarily on the conformational and allosteric properties of a target molecule of interest. In some embodiments, the method comprises screening candidate molecules to identify compounds having an activity for inhibiting a native form of an autoinhibited molecule of interest, and that lack activity for inhibiting a non-native form of the autoinhibited molecule of interest.

In some aspects, a screening method based on a luminescence-type assay is provided for the screening and selection of candidate allosteric inhibitory molecules.

It should be noted that the sequence of steps according to the method is not critical. For example, the steps of the screening method may be performed simultaneously or sequentially without any loss of accuracy or specificity being observed in the resulting pool of inhibitory compounds. Thus, the step wherein inhibitory activity of the candidate molecule is assessed for inhibiting a native form of an autoinhibited molecule of interest may take place before, after, or simultaneously with a step or steps to assess the inhibitory activity for a non-native form of the autoinhibited molecule of interest.

In particular embodiments, the autoinhibited molecule of interest is a protein, such as an enzyme. In some embodiments, the enzyme is a kinase, such as p-21-kinase (Pak).

In some embodiments, the non-native form of an autoinhibited protein, compound and/or molecule of interest may comprise an isolated non-autoinhibitory domain, or non-allosteric domain, such as a ligand binding domain, (e.g., a catalytic domain), or other second ligand binding domain, of said autoinhibited protein, compound and/or molecule, or a mutated form of said molecule that has other than a native amino acid or nucleic acid sequence. In this regard, a non-native form of an autoinhibited molecule of interest may comprise a mutant protein, such as a deletion, truncation, substitution, or other mutationally changed protein that alters the native sequence or arrangement of the native, non-mutated sequence. The modification or mutational change to the molecule of interest may be located at any site along the molecule. Therefore, modifications that would provide a non-native form of an autoinhibited protein, molecule and/or compound of interest may comprise an N-terminal, C-terminal or internal deletion, substitution, truncation, or other molecular rearrangement, or any combination of these.

The method provides highly diverse and novel groups of allosterically specific drug candidates. In particular, information about the conformational behavior of the autoinhibitory domains and/or autoinhibitory allosteric domains within an autoinhibited molecule of interest (e.g., protein, such as Paks), is employed in the design of a novel and invaluable screening and selection protocol for specific inhibitory compounds of a huge variety of molecules, such as proteins. By way of example, such proteins include a variety of enzymes. These enzymes include kinase and non-kinase like compounds, as well as compounds having kinase-like activity.

Inhibitory proteins, compounds and/or molecules and compositions enriched for the inhibitory proteins, compounds and/or molecules selected using the screening and selection methods described herein find a variety of therapeutic applications. For example, selected inhibitory molecules and mixtures of these inhibitory molecules are anticipated to have particular application in the treatment of diseases and conditions associated with or modulated by kinases, or molecules/compounds that have kinase-like activity. Such conditions include, by way of example, inflammation, cancers, immunodeficiency disorders, ageing, and the like. Hence, in yet another aspect, pharmaceutical preparations and treatments are provided comprising a composition enriched for the inhibitory proteins, molecules and/or compounds provided with the present methods.

In one aspect, a method comprising screening candidate compounds for activity in stabilizing autoinhibited (unactivated) forms of p21 and Rho effector proteins is provided. This group of proteins includes, but is not limited to, the Paks as well as protein kinases in the Ack, MRCK, MLK, p70^{s6k}, Rok, Citron, and PKN families. In addition, this group of proteins includes, but is not limited to, non-kinase effectors such as proteins in the WASP, WAVE, and Formin families. Specific examples of screens for inhibitors of MLK3 and the Formin, mDia1, are provided herein.

According to one aspect, a method is provided comprising identifying inhibitory molecules of an autoinhibited protein, molecule and/or compound. By way of example, an autoinhibited protein may comprise Paks, and the various classes of autoinhibited proteins that comprise Paks, including, by way of example, the class I and class II Paks. These classes comprise Pak1-Pak6.

In yet another broad aspect, a method is provided comprising identifying a chemical compound that stabilizes the autoinhibited forms of non-receptor, serine/threonine kinases, as well as phosphatases in which inhibition is mediated by an autoinhibitory domain.

According to yet another aspect, a method comprising identifying inhibitory compounds of autoinhibited small GTPase effectors is provided. Small GTPase effectors include, by way of example, Paks, MLKs, Acks and Roks, and also non-kinases such as the formins, WASPs, etc.

The following abbreviations are used throughout the description of the present invention:

Pak—p-21-activated kinases

ATP—adenosine triphosphate

FRET—Fluorescence Resonance Energy Transfer

KD—kinase domain.

PID—Pak Inhibitory Domain

WASP—Wiskott-Aldrich Syndrome Protein

PBD—p21-Binding Domain

NMR—nuclear magnetic resonance

### BRIEF DESCRIPTION OF THE DRAWINGS

The invention will be described in conjunction with the accompanying drawings, on which:

FIG. 1, according to one embodiment of the invention, illustrates the typical regulation of an autoinhibited protein by an “activator” protein. Binding of activator displaces the autoinhibitory domain and relieves autoinhibition. For Pak, the activator corresponds to the proteins Rac or Cdc42.

FIG. 2, according to some embodiments of the invention, illustrates two constitutively active forms of an autoinhibited protein: Left) The autoinhibitory domain has been mutated so that it cannot bind and inhibit the catalytic domain; Right) The autoinhibitory domain has been removed (either by proteolytic digestion or construction of a recombinant protein lacking the autoinhibitory domain).

FIG. 3, according to one embodiment of the invention, illustrates an example of an allosteric inhibitor (“I”) that binds the autoinhibitory domain (left) and therefore cannot inhibit the constitutively active form of the molecule (mutationally active, center, and protein fragment, right).

FIG. 4, according to one aspect of the invention, provides an example of a competitive inhibitor that directly binds the active site of a protein. Note that all protein forms are inhibited by “I”.

FIG. 5, according to some embodiments of the invention, presents a general 2-pronged illustration flow chart of the screening assay for use in screening candidate molecules for inhibitory compounds of an autoinhibited protein. The screening method includes two component steps. The order in which these steps are performed is not critical in any way, and one step may be performed before or after the other with an expectation of equal results. In addition, the two steps may also be performed simultaneously in different reaction media.

FIG. 6, according to one aspect of the invention, provides a detailed flow chart of the method employed for screening candidate compounds for inhibiting full length, wild-type Pak1.

FIG. 7, according to one aspect of the invention, provides polyacrylamide gel analysis of the recombinant Pak 1 expressed and purified that was used in the screening methods, as well as an illustration of the equipment and reagents (consumables) utilized in the screening methods.

FIG. 8, according to one embodiment of the invention, presents a sample data profile obtained using the screening method to identify inhibitors of full-length Pak1 (Sample Data: NCI plate, 4). The indicated control samples contain the non-specific kinase inhibitor, staurosporine. The Z′ value of the assay is at least 0.8 or greater.

FIGS. 9A-9C, according to one aspect of the invention, relate to a demonstration validating the use of ATP-dependent luminescence to measure the kinase activity of Pak1. In these assays, 384-well plates were used. 9A—The assay is exquisitely sensitive to Pak1 activity. 9B—Pak1 requires Cdc42 for activity. 9C—Inhibition of Pak1 by the non-specific kinase inhibitor, staurosporine, is readily detected.

FIG. 10, according to one aspect of the invention, presents data of active compounds being tested for their ability to also inhibit a mutationally activated form of Pak. Active compounds that inhibit full-length, native Pak1 were tested for their ability to inhibit a constitutively activated (by mutation) form of Pak2. Each bar represents a single reaction treated with an individual compound. High luminescence values reflect inhibition of Pak2 activity. Thus, wells treated with compounds resulting in low luminescence values (high kinase activity) represent allosteric inhibitors. These inhibitory compounds are incapable of inhibiting mutationally activated Pak2. Note that staurosporine, a non-specific kinase inhibitor that does not act by an allosteric mechanism, also inhibits mutationally activated Pak2 and consequently would be rejected by this screen.

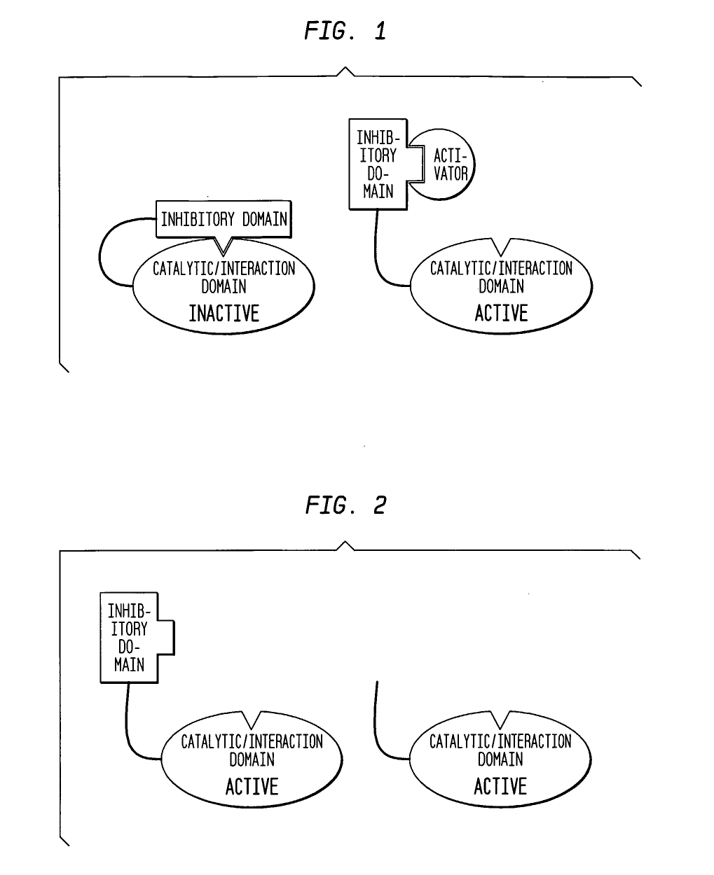

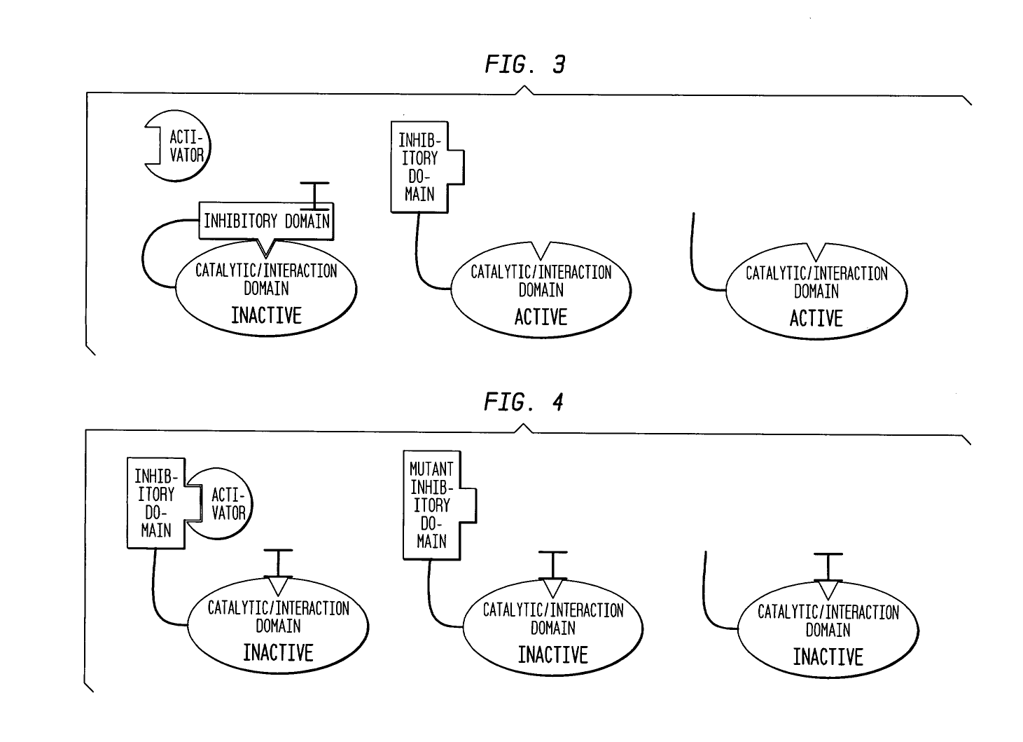

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

It should be noted that the singular forms, “a”, “an”, and “the” include reference to the plural unless the context as herein presented clearly indicates otherwise.

The term “candidate compound” or “candidate molecule” relates to a compound and/or molecule that is potentially capable of associating with an autoinhibited molecule, such as an autoinhibited protein. By way of example, such an autoinhibited protein may comprise a kinase or non-kinase molecule.

The term “inhibitory compound” relates to a candidate compound and/or molecule that is capable of conserving and/or maintaining a non-activated or native conformational state of an autoinhibited compound/molecule, such as an autoinhibited protein. An inhibitory compound may also be described as a compound/molecule that will bind and form a specific association with an autoinhibitory domain or part of said domain of an autoinhibited compound, and preserve a conserved, non-activated conformational state of the autoinhibited compound. The inhibitory compound may be further defined as being essentially free of inhibitory binding activity (20% or less) for a non-autoinhibitory domain. A non-autoinhibitory domain may comprise, for example, a ligand binding domain or a catalytic domain. By way of example, an inhibitory compound may be a natural substance, a biological macromolecule, or an extract made from biological materials such as bacteria, fungi, or animal (particularly mammalian) cells or tissues, an organic or an inorganic molecule, a synthetic test compound, a semi-synthetic test compound, a carbohydrate, a monosaccharide, an oligosaccharide or polysaccharide, a glycolipid, a glycopeptide, a saponin, a heterocyclic compound, a structural or functional mimetic, a peptide, a peptidomimetic, a derivatized test compound, a peptide cleaved from a whole protein, or a peptide synthesized synthetically (such as, by way of example, either using a peptide synthesizer or by recombinant techniques or combinations thereof), a recombinant compound, a natural or a non-natural test compound, a fusion protein or equivalent thereof and mutants, derivatives or combinations thereof. An inhibitory compound also includes all pharmaceutically acceptable salts of these and other specific types of inhibitory compounds.⁴⁵ An inhibitory compound may also be described as comprising a class of non-active site, or non-catalytic site directed molecules or compounds.

An “autoinhibited state” of an autoinhibited molecule, for example, an autoinhibited protein of interest, relates to the state of a molecule as it exists in the absence of activation or other change to its native conformational arrangement/sequence.

The term “autoinhibited molecule” relates to a protein, molecule and/or compound in an autoinhibited state. An autoinhibited molecule may be further defined as comprising 1 or more autoinhibitory (allosteric) domain or domains and 1 or more non-allosteric and/or non-autoinhibited domain or domains. An autoinhibited molecule may comprise, for example, an autoinhibited protein, peptide, nucleic acid (RNA, DNA), fragment, or analog or derivative of a protein or peptide, or any combination of these.

The term “autoinhibitory domain” relates to a region, fragment, site, motif or segment of an autoinhibited protein, molecule and/or compound that is capable of regulating the function of a non-autoinhibited domain (e.g., a ligand binding domain, a catalytic domain) of the autoinhibited protein, molecule and/or compound. While not intending to be limited to any particular mechanism of action, it is envisioned that an autoinhibitory domain negatively regulates the function of another non-autoinhibited domain through specific and coordinated intramolecular interactions. An autoinhibitory domain may be operationally defined as a region, fragment, site or motif of an autoinhibited protein, molecule and/or compound, that when mutated or removed from the autoinhibited protein, molecule and/or compound, will increase the pharmacological activity of that autoinhibited molecule, and render it in an activated, non-native, conformation. By way of example, an autoinhibitory domain may be described as other than a ligand binding domain and other than a catalytic domain.

The term “non-autoinhibitory domain” relates to a region, fragment site, motif or segment of an autoinhibited protein, molecule, and/or compound that is not responsive and/or amenable to direct interaction with an allosterically and/or autoinhibitory domain specific inhibitory molecule and/or compound. By way of example, a non-autoinhibitory domain is other than an autoinhibitory domain and/or allosteric domain. One example of a non-autoinhibitory domain is a ligand binding domain or a catalytic domain.

The term “activated state” relates to the state of a molecule, such as an autoinhibited protein, that results in disruption of the activation segment of a kinase domain of that molecule. In an activated state, a molecule, such as a protein (e.g., kinase) becomes catalytically active. An activated state typically occurs in the presence of phosphorylation of the autoinhibited molecule (e.g., the kinase).

The term, “allosteric” relates to a characteristic of a protein, molecule and/or compound that results in a conformational change of the protein, molecule and/or compound. A protein, molecule and/or compound that is “allosteric” is one whose activity or efficiency changes in response to the binding of a compound or molecule, such as a ligand, to an allosteric binding site of the protein, molecule and/or protein. The allosteric binding site may be further described as at least partially distinct from a non-allosteric binding site of the protein, molecule and/or protein. The non-allosteric and/or non autoinhibitory binding site for a second molecule or compound may, for example, be a ligand binding domain. By way of example, for protein enzymes, this non-autoinhibitory binding site may be described as a ligand binding domain and/or a catalytic binding site or domain.

The term “allosteric activation” relates to molecular (e.g., protein or peptide) changes in an autoinhibited molecule that result in an increase in the activity of the molecule (protein). For example, allosteric activation of a p21-kinase results in an increase in the enzyme activity of the kinase, and also results in a conformational change in the kinase that is different from the native conformation of the kinase.

The term “allosteric inhibition” relates to the inhibition of activity that results when an autoinhibited protein or other molecule/compound interacts with an inhibiting compound. The interaction of the inhibiting compound with the autoinhibited protein functions to maintain the protein in a native, conformationally conserved orientation, and/or inhibits the activation of that autoinhibited protein, molecule or compound (e.g., enzyme).

A composition that is described herein as “enriched” for a particular pharmacologically or biochemically active agent, for example, is further defined as a composition that contains a higher concentration of a particular protein, molecule and/or compound, or demonstrates a greater pharmacological or biochemical activity associated with a particular protein, molecule and/or compound, relative to the concentration or detectable associated pharmacological or biochemical activity of that protein, molecule and/or compound as it is otherwise found in nature and/or in a non-purified or non-screened compositional form. By way of example, a pharmacologically or biochemically active agent may compromise an inhibitory compound as described herein.

The term “essentially free” of activity for binding to a non-autoinhibitory domain of an autoinhibited molecule of interest is further described as having a de minimus (for example, 10% or 5% or less) inhibitory activity from binding to a non-autoinhibitory domain (such as a ligand binding domain or catalytic domain) of an autoinhibited molecule of interest. By way of example, a de minimus inhibitory activity may comprise 20% or less, or is some cases, 10% or less, of a detectable inhibitory activity attributable to binding of an inhibitory compound to a non-autoinhibitory binding domain of an autoinhibited molecule of interest (protein), present at a concentration of about 10 μM.

The term “homolog” relates to a polypeptide having a degree of homology with a wild-type amino acid sequence.

The term “homology” relates to the degree of complementarity or commonality of sequence between two or more amino acid or nucleic acid sequences. There may be partial (20% or more) homology or complete (at least 90% or more) homology between molecules (proteins, peptides, nucleic acid sequences). In some embodiments, a protein or polypeptide comprises an amino acid sequence that is substantially homologous to a wild type protein. Substantially homologous relates to 2 or more sequences that have a degree of 80% or more homology as between their sequences.

The term “inactivated conformational state” relates to the configuration of a protein or other molecule in its inactivated state or in its unphosphorylated state.

A “kinase” relates to an enzyme that transfers a phosphate group from ATP to a molecule. For example, glucokinase phosphorylates glucose, using ATP. Hexokinase phosphorylates hexoses, using ATP. A protein kinase phosphorylates a protein, using ATP; this is an important type of reaction in biochemistry, as phosphorylation modulates the shape, and hence the activity, of a protein.

The term “ligand binding domain” relates to a domain or domains of an autoinhibited molecule/compound that binds other than an inhibitory compound. A ligand binding domain may include, for example, a catalytic domain or a domain that binds to other than an inhibitory compound.

The term “mutation” relates to an alteration in a naturally-occurring amino acid or nucleic acid sequence. For example, a mutation to a nucleic acid sequence may comprise an insertion, deletion, frame shift mutation, silent mutation, non-sense mutation, substitution or missense mutation. A mutated amino acid sequence may compromise one or more substituted or deleted amino acids. In some embodiments, a mutated protein sequence encoded by a mutated nucleic acid sequence will comprise at least one amino acid alteration from a naturally occurring sequence.

The term “mutant” refers to a molecule, such as a protein, polypeptide, peptide, nucleic acid sequence or fragment thereof, having a primary amino acid or nucleic acid sequence that differs from the wild type sequence by one or more amino acid or nucleic acid additions, substitutions, deletions, rearrangements, fusions, modifications (chemical or otherwise) or any combination of these.

The term “native” state relates to the form of a compound as it exists in nature. By way of example, a native state of a compound or molecule (e.g., protein) would comprise a protein that has a full length amino acid or nucleic acid sequence unchanged from its native, wild type amino acid or nucleic acid sequence.

The term “non-native state” relates to a protein, peptide or other molecule that is in other than its native state. For example, a protein or peptide that has been shortened, truncated, or other wise modified such that its tertiary structure is altered from a native “wild type” conformation may constitute a “non-native” peptide or protein.

The term “p21” relates to the small GTPase family comprising Cdc42, Rac₂, and related proteins.

The terms “pharmacological activity” and “biochemical activity” relates to a pharmacologically or biochemically detectable change attributable to the presence or production of a compound either in vitro or in vivo (in cellulo).

The term “part” or “fragment” relates to less than a full length molecule, such as a full length polypeptide, or nucleic acid sequence characteristic of the wild-type sequence. A part or fragment may comprise one or more large contiguous sections of sequence or a plurality of small contiguous sections. A peptide may comprise other elements, for example, it may compromise a fusion molecule with another protein, peptide, nucleic acid, or other molecule (such as a molecular tag (e.g., His-tag) that may be used in isolation or crystallization).

The term “substantially identical” relates to a nucleic acid sequence or amino acid sequence that is at least 60, 70, 80, 90, 95, or 100% identical to that of another nucleic acid sequence or amino acid sequence.

The term “substantial homology” relates to a protein or nucleic acid sequence of amino acids within a peptide, or nucleotides within a nucleic acid sequence, that bears about a 65%, 75%, or even 95% sequence identify to another reference nucleic acid or peptide.

The term “substantially purified” relates to a compound that has been separated from other components. For example, a compound or factor is “substantially purified” when it is at least 50% or more, by weight, free from other proteins and/or other molecules with which it is naturally associated. A “substantially purified” composition and/or preparation will comprise 50% by weight, or 70% to 95% by weight of a compound of interest. The compound may be obtained by chemical synthesis, separation of the compound from natural sources, or production of the factor by recombinant means in a host cell, including a host cell that may not naturally produce the compound. The compound is preferably included at a concentration that is at least 2, 4, 5, or 10 times higher than it otherwise exists in nature or as part of a non-purified or unprocessed composition, as measured using standard analytical techniques known to those of skill in the art. Some of these techniques include, by way of example and not limitation, polyacrylamide gel electrophoresis, column chromatography, such as immunoprecipitation, optical density, HPLC analysis, or western analysis.⁵¹

The term “variant” refers to a naturally occurring polypeptide which differs from a wild-type sequence. A variant may be found within the same species (i.e., if there is more than one isoform of the protein), or may be found within a different species. In some embodiments, the variant has an at least 90% sequence identity with the wild type sequence. In other embodiments, the variant has 20 mutations or less compared to an entire wild-type sequence. In yet other embodiments, the variant has 10 mutations or less, most preferably 5 mutations or less, compared to an entire wild-type sequence.

The term “wild type” refers to a polypeptide, peptide, protein or nucleic acid molecule having a primary amino acid sequence or nucleic acid sequence that is identical to the native polypeptide, protein, or nucleic acid molecule (for example, a human protein).

The term “Z′ value” relates to a measure of an assay dynamic range and variability. Z′ value may be interpreted according to the following scale: Z′ 1=perfect assay; 0.5-1=excellent; 0.0-0.5=poor; <0=unacceptable.

The following formula has been used in the definition of Z′ value:

$${Z}^{′} = 1 - \frac{3 \times Stnd Dev of sample + 3 \times Stnd Dev of Control}{mean of sample - mean of control}$$

### DESCRIPTION

Based on structural and functional similarity between allosteric inhibitors identified by the present inventors, the invention provides in one aspect a dual screening method for identifying highly specific inhibitory compounds that bind an autoinhibitory domain of an autoinhibited molecule/compound (e.g., protein), and that are essentially free of binding for a non-autoinhibitory domain (such as a ligand binding domain, catalytic binding domain) of that autoinhibited molecule/compound (e.g., protein).

The inhibitory molecules herein may also be described as allosteric inhibitory molecules. By way of example, such allosteric inhibitory molecules may comprise, for example, allosteric inhibitors of p-21-activated kinase (Pak). The allosteric inhibitory molecules/compounds provided herein bind and form a specific association with an autoinhibited compound, such as an autoinhibited protein, so as to preserve a conserved, non-activated conformational state of the autoinhibited compound.

In some embodiments, the allosteric inhibitory compounds may be described as comprising Pak inhibitors. By way of example, such inhibitors include class I and class II Pak inhibitors, Rho-activated protein inhibitors, autoinhibited non-receptor serine/threonine kinase inhibitors, phosphatase inhibitors, and autoinhibited small GTPase effector inhibitors.

In some aspects, methods for identifying compounds that antagonize activation of autoinhibited proteins, such as p21- and Rho-activated proteins, are provided. The compounds act by binding to a distinct, autoinhibitory domain, and thereby stabilize an autoinhibited conformation of the protein.

In some embodiments, the allosteric inhibitors are specific for binding a targeted inhibitory domain, such as a Pak inhibitory domain (PID). In this manner, Pak becomes stabilized in its native, autoinhibited conformation. Targeting the inhibitory domain, PID, provides greater specificity than targeting a catalytic or other non-autoinhibitory site of an autoinhibited molecule or compound because of the presence of highly conserved regions present in many autoinhibited molecules (proteins). Furthermore, inhibitory compounds targeting the autoinhibitory domain (e.g., PID), rather than a non-autoinhibitory (e.g. catalytic) domain may discriminate between closely related groups of kinases, such as the p-21-activated kinases, the group A and group B Paks.

Advantageously, the discriminating nature of the presently described dual screening methods permits the functional discrimination of these and other closely related kinase and other subfamilies. This illustrates yet another advantage of the present screening methods over those that target the kinase domain (KDs) of an autoinhibited protein. For example, the KD of group A and group B Paks are more highly conserved in sequence than the N-terminal regions, thus strategies targeting the KD are more likely to identify nonspecific inhibitors that target both the Group A and Group B Paks⁴¹. In contrast, using the present dual screening method, specific inhibitors of either the Group A or Group B Paks may be conveniently identified and isolated.

In some embodiments, the screening method comprises screening candidate compounds for activity that inhibits the wild-type molecule (e.g., protein or enzyme), but not a constitutively active form of that molecule (e.g., protein, enzyme). For example, the constitutively active form of Pak may comprise in some embodiments a mutant of Pak, such as a deletion or substitution mutant of Pak. By way of example, such a mutant may comprise a Pak protein in which the leucine at position 107 has been deleted or substituted (L107F). Leucine 107 has been described as an important residue for the interaction of the PID with the kinase domain (KD)⁴⁸. Mutation of this residue to phenylalanine (L107F) abolishes the ability of the PID to interact with the KD and inhibit kinase activity.⁴⁵ Consequently, this mutant Pak is constitutively active and inhibitors of this mutant directly target the active KD.

In some aspects, the screening method takes the form of a luminescence-based assay. Other methods may also be used to measure kinase activity. For example, kinase activity may be measured by transfer of radiolabeled phosphate onto a substrate.

Many other methods may also be used to measure kinase activity to those of skill in the art, and applied in the present screening methods given the disclosure provided herein.

By way of example, radioactivity based methods may also be used. These methods include, for example, filter-based methods (a standard method) and scintillation proximity assays (SPA). Fluorescence-based assays may also be used. By way of example, such fluorescence-based assays include FRET (Fluorescence Resonance Energy Transfer) and fluorescence polymerization. These and other assays that may be used in the practice of the present invention are described in “High Throughput Screening Methods and Protocols”, by William P. Janzen (Humana Press), published April 2002. ISBN:0-89603-889-0, which reference is hereby incorporated herein in its entirety by reference.

In some of these embodiments, the luminescence-based assay permits the monitoring of kinase activity as a measure of residual ATP in a reaction following kinase-mediated ATP hydrolysis.

In some embodiments, ATP hydrolysis is measured as a readout of the autoinhibitory interaction of the autoinhibitory domain (e.g., the PID of Pak) with a kinase domain (KD) of that autoinhibited molecule (e.g., protein, enzyme (Pak). This is an endpoint assay in which kinase reactions are allowed to proceed until a predetermined timepoint. At the predetermined timepoint, a detection mixture containing luciferase and luciferin is added that stops the kinase reaction, and utilizes the residual ATP to convert luciferin to oxyluciferin. The production of oxyluciferin results in an accompanying emission of a photon of light. The intensity of the emitted light may then be linearly correlated with ATP concentration. Thus, inhibited reactions produce a positive luminescent signal relative to control reactions due to the inhibition of ATP consumption.

The luminescence-based screening method is highly homogeneous since the only manipulation is the addition of the detection mixture. Another advantage of the assay is that it is relatively insensitive to fluorescence or absorptive properties of individual compounds, which is a complication with other types of assays.

Candidate compounds emerging from the dual positive/negative selection screen of the present methods may be screened to measure inhibitory potency in vivo. This may be accomplished, for example, by screening the selected pool of candidate compounds for inhibitory activity in a culture of living cells.

In some aspects, a protein is provided that may be a wild type enzyme, or part thereof, or a mutant, variant or homolog of such a protein. In some embodiments, the mutant has at least 90% sequence identity with the wild type sequence. In other embodiments, the mutant may be described as having a sequence that differs from the wild-type sequence by the presence of a deletion, substitution, or insertion that affects a region of the molecule near or at the autoinhibitory domain of the autoinhibited molecule. For example, an autoinhibited protein that has been mutated may include 1 or more, or even 20, single amino acid or nucleic acid mutations or more as compared to the native, wild-type sequence.

Inhibition of hybridization of a completely complementary sequence to the target sequence may be examined using a hybridization assay (e.g., Southern or Northern blot, solution hybridization, etc.) under conditions of reduced stringency. A sequence that is substantially homologous or a hybridization probe may be used to compete for and inhibit the binding of a homologous sequence to the target sequence under conditions of reduced stringency. Conditions of reduced stringency may permit non-specific binding. The absence of non-specific binding may be tested using a second target sequence which lacks complementarity (e.g., less than about 30% homology or identity). A substantially homologous sequence or probe will not hybridize to a second non-complementary target sequence under stringent conditions.

A Pak or other autoinhibited protein or peptide may exist in an autoinhibited state or an active state. The autoinhibited state results in perturbed catalytic function of the protein, or perturbs the ability of the protein to interact with another ligand. An autoinhibited state typically occurs in the absence of phosphorylation of the kinase.

If, after testing, it is determined that a candidate compound inhibits or potentiates an autoinhibited state of a protein, the candidate compound may be classified as a ligand. The compound may be used to select or design other inhibitory compounds, or to obtain other like inhibitory compounds from a library of compounds that may comprise any variety of potentially inhibitory molecules, such as peptides, proteins or other compounds, including small organic molecules and other collections of molecules available from commercial molecular/chemical libraries.

Additional details concerning screening methods, development and design of small molecule test compounds and ligands, and methods of treatment and other downstream applications may be found in U.S. Published Patent Application, US 2004/0132634—Sicheri et al., the entire contents and disclosure of which is hereby incorporated by reference.

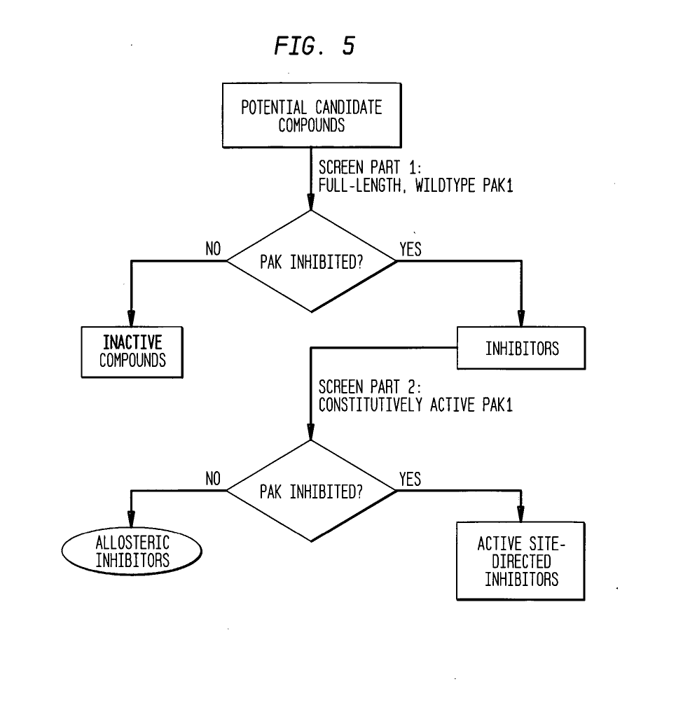

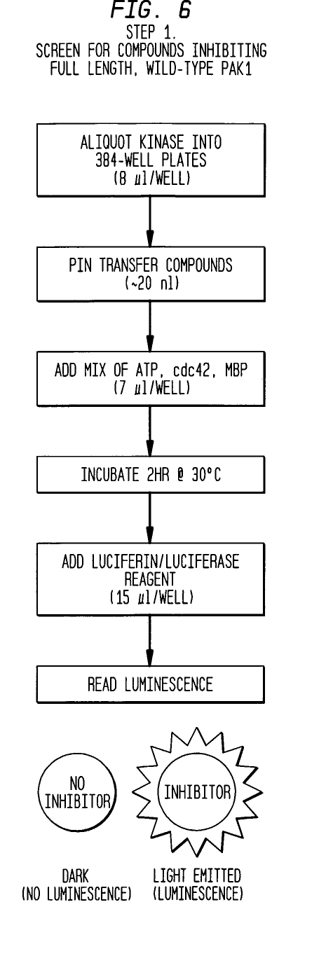

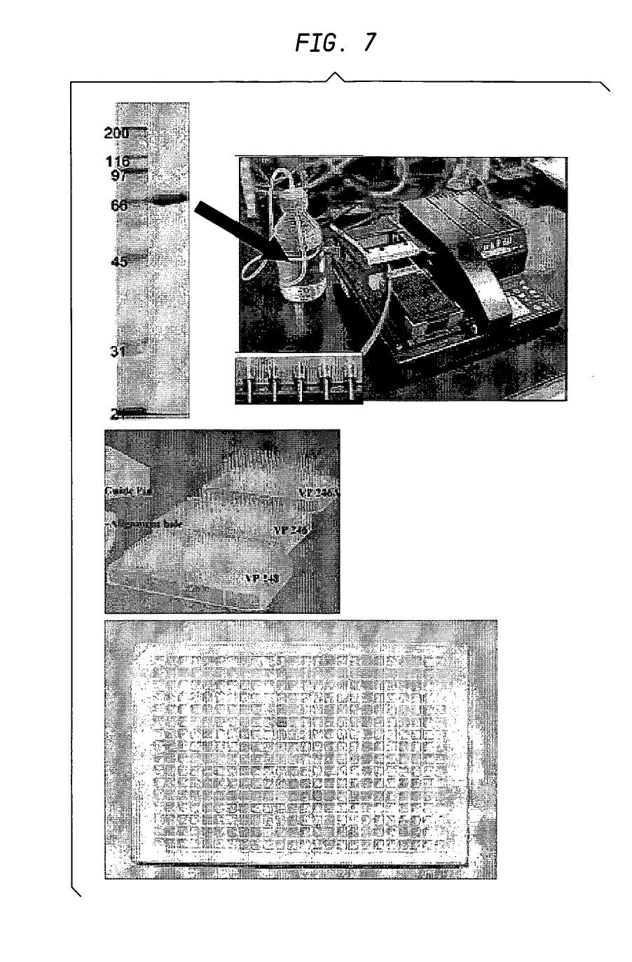

The screening method to identify allosteric autoinhibitory compounds may take many forms. A flow chart of one embodiment of the screening method is depicted in FIG. 5. One example comprises a dual step screening of candidate molecules against an autoinhibited molecule of interest in two forms: a) a “constitutively active” form comprising a fragment or mutant of the full-length protein that lacks, or has an inactivating mutation in, the autoinhibitory segment and b) an activated form, consisting of the autoinhibited form in the presence of an activating binding partner. In some embodiments, the selected allosteric inhibitors are those compounds that allosterically inhibit the protein of interest, and are identified as those compounds that are able to inhibit the activated form bound to an activating binding partner (b), but not the constitutively active form (a).

In another aspect, the screening method is designed to identify inhibitory compounds focused on the physical interaction, as opposed to consequent inhibition, of the autoinhibitory domain with the functional domain of a protein or other molecule. This interaction may be measured in many ways, however the goal of the assay is to screen for inhibitory compounds that increase the affinity of the interaction.

According to yet another aspect, a method comprising identifying compounds that stabilize the autoinhibited form of class I Paks is provided. This class of Paks may comprise Pak1, Pak2, and Pak3. In some embodiments the class I Pak is Pak 1.

According to some aspects, a method is provided comprising screening a library of candidate compounds. In some embodiments, the method provides a step wherein candidate compounds are identified that stabilize the autoinhibited form of class I Paks. In some embodiments, the method utilizes recombinant, wild-type, Pak1 purified from Sf9 cells. A second screen of the candidate compounds is also conducted using a non-native form of the kinase, such as the isolated kinase domain. The isolated kinase domain may be generated according to some applications of the method by a limited proteolysis of a wild-type Pak1 protein. According to some embodiments, recombinant Cdc42 is added to the full-length kinase to stimulate activity.

In some embodiments, the kinase activity of these two proteins (wild-type full length kinase, and isolated kinase domain) is measured in parallel using a validated luminescence-based assay. In this assay, kinase activity is based on a measurement of the residual ATP in the reaction following kinase-mediated ATP hydrolysis (Kinase Glo®; Promega®). This is an endpoint assay in which kinase reactions are allowed to proceed until a predetermined timepoint at which point the addition of the Kinase Glo® detection mix containing luciferase and luciferin stops the kinase reaction and utilizes the residual ATP to convert luciferin to oxyluciferin with the accompanying emission of a photon of light. Intensity of the emitted light is linearly correlated with ATP concentration. In these embodiments, inhibited reactions are identified where a positive luminescent signal is produced relative to a control reaction, and signals the inhibition of ATP consumption (FIG. 6).

While the present invention is not necessarily limited to such applications, various aspects of the invention may be appreciated through a discussion of the several examples presented below using this context.

### EXAMPLE 1

### Description of the Assay

The present example provides a detailed description of one example of the many forms of the assay that may be used in identifying an inhibitory compound that maintains an autoinhibited state of an autoinhibited molecule of interest, such as an autoinhibited protein. The autoinhibited state of the molecule may be further described as a molecule that is in an unactivated, conformationally conserved state. Typically, the unactivated, conserved state of an autoinhibited protein has a native amino acid length and conformation.

The isolated kinase domain or full-length Pak1 in assay buffer is aliquotted into individual wells of a 384-well plate using a Bio-Tek MicroFill®. (8 μl/well). Individual candidate compounds are transferred into each well by manual transfer using disposable poly-propylene 384-pin arrays. These devices transfer ˜20 nl per pin. The kinase reaction is initiated by the addition (by MicroFill®) of a reaction mixture containing substrate (myelin basic protein), ATP, and, for reactions containing full-length Pak1, Cdc42 (charged with the non-hydrolyzable GTP analogue GTPγS) (7 μl/well). Reaction plates are lidded and incubated at 30° C. for 2 hours. The reaction is stopped by the addition of Kinase Glo® reagent (15 μl/well), and is incubated at room temperature for 10-30 minutes to allow development of luminescence. Luminescence is read in a Cary Eclipse (Varian®) fluorometer/luminometer outfitted for reading 384-well plates.

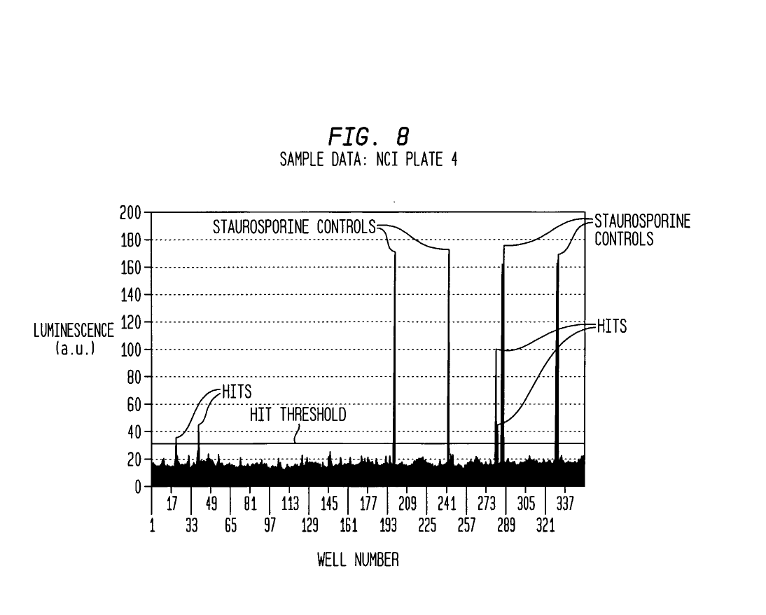

A histogram of luminescent values is prepared on a plate-by-plate basis and values falling greater than 3 standard deviations above the control mean luminescence for full-length Pak1, but not the isolated catalytic domain, are scored as “hits.” (FIG. 8).

### EXAMPLE 2

### Screen for Allosteric Inhibitor of MLK3

A kinase domain (amino acid residues 115-384) of human MLK3, as well as full length human MLK3 cDNA (847 amino acids), are cloned into a His-tagging, baculoviral transfer vector such as those offered by Clontech® (Bac-to-Bac® system). A recombinant baculovirus may then produced by standard recombinant methods.

Sf9 cells were infected and the recombinant baculovirus amplified. The amplified virus is then used to produce the kinase domain and the full length form of MLK3. This is then purified by Nickel-agarose chromatography. Optimal conditions for the kinase assay are then established so that ˜75% of ATP is depleted within two hours of incubation with Cdc42-activated MLK3.

Two screens were then carried out as part of the screening method to identify candidate inhibitory compounds. Candidate compounds were provided using a small molecule library. In the first screen, each candidate compound was assayed against Cdc42-activated full length MLK3, to identify those compounds that were capable of inhibiting the activation of the full length, native protein, in this case, MLK3. Those compounds that were found to be capable of inhibiting the full length, native form of the native protein, such as MLK3, were then selected. This selected pool of candidate compounds were then subject to a second “negative” screen. In the second “negative” screen, each of the selected candidate compounds of the pool was assayed to measure activity for binding to an isolated kinase domain of the protein, in this case, pMLK3, to identify those candidate compounds that were able to bind this active site of the protein (i.e., non-allosteric or “competitive” inhibitors). The selected candidate molecules that did not bind to this non-allosteric active site were then selected as candidate inhibitory compounds.

Potential inhibitory compounds therefore comprise those compounds that inhibit kinase activity of a full length, native protein, and that do not bind the isolated active site of that protein, using a recombinant fragment of the MLK3 protein that included the active site.

### EXAMPLE 3

### Screen for Allosteric Inhibitor of mDia1 (A Formin Family Protein)

The present example demonstrates the use of the double screen assay using a formin family protein. In this example, the formin family protein, mDia1, was used.

The C-terminal portion, mDia1 (mDia-C; a constitutive active form, comprising amino acid residues 549-1255 of human mDia1), as well as the inhibitory N-terminal portion (mDia-N; amino acids 1-548), was cloned into a GST-tagging, E. coli expression vector such as those offered by GE Healthcare® (pGex® system). E. coli were then transformed with the vector, and allowed to express the corresponding recombinant proteins. Both of the recombinant proteins expressed were then purified on glutathione-agarose beads according to the manufacturer's protocol.

Assay: mDia-C (constitutively active mDia) or a mixture of mDia-C, mDia-N, and RhoA (Rho-activated mDia) were aliquotted into 384-well reaction plates containing 2×XB buffer containing ATP, physiological salts, EGTA, and MgCl₂. Concentrations of components in the two reactions are chosen to produce comparable actin polymerization kinetics. The assay conditions were optimized to minimize spontaneous actin polymerization. Compounds to be screened were then transferred in the reaction plates by pin transfer from compound stock plates. Actin polymerization was initiated by the addition of an equal volume of 8 μM actin, 5% of which is covalently labeled with pyrene, in G buffer (to maintain the actin in a monomeric state prior to assay initiation). The kinetics of actin polymerization in each well was measured in a fluorescence plate reader. Polymerization of pyrene-actin caused a detectable increase in the pyrene fluorescence. Inhibitors of mDia1 were identified as those compounds that decreased fluorescence emission.

Additional details regarding the adaptation of the assay as described herein for mDia1 may be provided through a review of Otomo, T., et al. (2005)⁵³ and Li, F. et al. (2003)⁵⁴, both references being specifically incorporated herein by reference.

Compounds that prevent stimulation of actin polymerization in the Rho-activated reaction, and do not prevent stimulation of actin polymerization of the constitutively active mDia reaction, represent candidate inhibitory compounds of mDia. mDia inhibitory compounds should not target RhoA. This may be confirmed by assaying RhoA activation of another RhoA effector, such as Rho kinase (ROK), in vitro, in the presence or absence of the inhibitor.

### EXAMPLE 4

### Screen for Allosteric Inhibitor of Protein Kinase D

In the present example, the pleckstrin homology domain of Protein Kinase D serves as the autoinhibitory domain.

A mutant form of human PKD, missing its pleckstrin homology domain (PKD delta PH; constitutive active form, lacking amino acid residues 429 to 557 of human PKD), as well as non-mutant, full length PKD, was cloned into a His-tagging, baculoviral transfer vector, such as those offered by Clontech® (Bac-to-Bac® system). A recombinant baculovirus was produced by standard recombinant methods. Sf9 cells were infected, and the recombinant baculovirus was amplified. The amplified virus was used to produce the wild-type and the mutant form of the PKD, and the wild-type and the mutant form of the PKD was then purified by Nickel-agarose chromatography.

200 ng of wild-type PKD or the mutant (delta PH) form of PKD was aliquotted into individual wells of a 384-well plate using a Bio-Tek MicroFill® (8 μl/well). Individual compounds are then transferred into each well by manual transfer using disposable poly-propylene 384-pin arrays. These devices transfer ˜20 nl per pin.

The kinase reaction may be initiated by the addition (by MicroFill®) of a reaction mixture containing ATP, and, for reactions containing wild-type PKD, 70 ng PKC epsilon (purchased from a commercial source such as Calbiochem®) in the presence of phosphatidyl serine/phorbol 12,13-dibutyrate (PS/PDB) vesicles (prepared by dehydrating 300 μg of PS under ethanol (2001) in a Speedvac® dehydrator and then sonicating the dried lipid into kinase buffer (typically 300 μl) in the presence of added PDB and 0.05% nonionic detergent (Triton X-100®) and kinase buffer in a reaction volume of 20 μl on ice. Reaction plates are then lidded and incubated at 30° C. for 2 hours. The reaction is stopped by the addition of Kinase Glo® reagent (15 μl/well), and is incubated at room temperature for 10-30 minutes to allow development of luminescence. Luminescence is read in a Cary Eclipse® (Varian®) fluorometer/luminometer outfitted for reading 384-well plates.

A histogram of luminescent values is prepared on a plate-by-plate basis and values falling greater than 3 standard deviations above the control mean luminescence for full-length PKD but not the delta-PH form are scored as “hits”.

### EXAMPLE 5

### Screen of Diverse Candidate Molecule Library for Allosterically Interactive Compounds

The present example provides an example of the screening method as applied to a library of molecules of diverse structure and unscreened conformational or other activity. The present example illustrates that the method may be applied to any group of diverse biological and/or chemical compounds.

Any desired library of diverse molecules may be used in the practice of the present method. Several commercial and publically available sources have readily available libraries of large numbers of molecules that may be used in the herein described protocols. By way of example, several libraries of highly diverse molecules are available from the “Open Chemical Repository” of the Developmental Therapeutics Program of the National Cancer Institute. Particular libraries from this source include the “Diversity Set”, “Mechanistic Set”, “Challenge Set” and “Natural Product Set”, to name a few. In addition, diverse collections of compound libraries are available from commercial sources, including Chemical Diversity, Inc., (San Diego, Calif.) (e.g., “Discovery Collection”, “Targeted Collection”, and various pathway based libraries). Other libraries of diverse compounds are also available from Chembridge, Inc. (e.g., “DiverSet”), Maybridge, PLC (Cornwall, England) and Tripos, Inc. (St. Louis, Mo.).

The present example presents a new method, in the form of a high-throughput screen, specifically designed to identify inhibitors of Pak1 that act by stabilizing Pak's autoinhibited, conserved conformation. This method could be adapted by anyone skilled in the art to screen for inhibitors of any autoinhibited protein that possesses an autoinhibitory domain and a catalytic domain. Numerous proteins are known that comprise an autoinhibitory domain. Presentation of some of these proteins are provided in Pufall & Graves (2002)⁵², which reference is specifically incorporated herein by reference. Exemplary autoinhibited molecules are listed in the following Table 1.

TABLE 1
Examples of Autoinhibition
LIGAND BINDING

| | |
|---|---|
| Protein: | NF-B · transcription factor |
| Inhibited activity: | Transcription activation by CBP/p300 binding domain |
| Inhibitory/activation: | C-terminal region masks N-terminal interaction |
| | domain/PKA binding phosphorylation |
| Reference: | Zhong et al. (1998)⁵⁶ |
| Protein: | Leu3p, transcription factor |
| Inhibited activity: | Transcription activation |
| Inhibitory/activation: | Internal region masks activation/activate |
| | by alpha-isopropylmalate |
| Reference: | Wang et al.(1999)⁵⁷ |
| Protein: | Nuclear receptors |
| Inhibited activity: | Transcription activation |
| Inhibitory/activation: | DNA binding domain/response element binding |
| Reference: | Lefstin & Yamamoto (1998)⁵⁸ |
| Protein: | TFIIIc131, pol III transcription factor |
| Inhibited activity: | TFIIIB70 binding |
| Inhibitory/activation: | Masking TPR arrays/Brf1 association |
| Reference: | Moir et al. (2002)⁵⁹ |
| Protein: | SNAPc, small nuclear RNA-activating complex |
| Inhibited activity: | DNA binding |
| Inhibitory/activation: | C-terminal region of SNAPc p190 subunit/association with Oct-1 |
| Reference: | Mittal et al. (1999)⁶⁰ |
| Protein: | TBP, TATA-binding protein |
| Inhibited activity: | DNA binding, DNA bending |
| Inhibitory/activation: | N-terminal region/SNAPc binding to N-terminal |
| | region, TFIIB association |
| Reference: | Kuddus & Schmidt (1993), |
| | Mittal & Hernandez (1997), |
| | Zhao & Herr (2002)⁶¹ |
| Protein: | Hoxb-1, Drosophila Lab (labial) homeodomain transcription factor |
| Inhibited activity: | DNA binding |
| Inhibitory/activation: | Hexapeptide motif/EXD protein binding |
| Reference: | Chan et al. (1996)⁶² |
| Protein: | IRF4 (Pip), transcription factor |
| Inhibited activity: | DNA binding and transcription activation |
| Inhibitory/activation: | C-terminal region/PU.1 binding to C-terminal region |
| Reference: | Brass et al. (1996)⁶³ |
| Protein: | p53, transcription factor |
| Inhibited activity: | DNA binding |
| Inhibitory/activation: | C terminus/phosphorylation |
| Reference: | Ko & Prives (1996)⁶⁴ |
| Protein: | IRF 3, interferon regulatory factor transcription factor |
| Inhibited activity: | DNA binding, activation, nuclear localization |
| Inhibitory/activation: | C-terminal region/phosphorylation during viral infection |
| Reference: | Lin et al. (1999)⁶⁵ |
| Protein: | Esx1, homeodomain transcription factor |
| Inhibited activity: | DNA binding, nuclear entry |
| Inhibitory/activation: | PF/PN motif/SH3 domain |
| Reference: | Yan et al. (2000)⁶⁶ |
| Protein: | PTEFb, transcription elongation factor |
| Inhibited activity: | RNA (TAR element) binding |
| Inhibitory/activation: | C-terminal region of cyclinT1/binding of TATA-SF1 to cyclinT1 |
| Reference: | Fong & Zhou (2000)⁶⁷ |
| Protein: | Bid, BH3 interacting domain protein |
| Inhibited activity: | Apoptosis via protein: protein |
| Inhibitory/activation: | N-terminal pseudolig and/domain protein protein: protein |
| | Bcl-XL binding |
| Reference: | Tan et al. (1999)⁶⁸ |
| Protein: | Vinculin, actin-membrane linker |
| Inhibited activity: | F-actin binding |
| Inhibitory/activation: | N-terminal region/acidic phospholipids |
| Reference: | Bakolitsa et al.(1999), |
| | Johnson & Craig (2000)⁶⁹ |
| Protein: | Alpha-actinin |
| Inhibited activity: | Titin binding |
| Inhibitory/activation: | Z-repeat motif pseudoligand/PIP2 binds actin-binding domain |
| Reference: | Young & Gautel (2000)⁷⁰ |

ENZYMATIC ACTIVITY

| | |
|---|---|
| Protein: | PAS kinase, period, aryl hydrocarbon single-minded homology domain |
| Inhibited activity: | Kinase |
| Inhibitory/activation: | PAS domain/metabolites |
| Reference: | Rutter and McKnight (2001)⁷¹ |
| Protein: | Vav, GDP-GTP |
| Inhibited activity: | GEF exchange factor (GEF) GEF activity |
| Inhibitory/activation: | N-terminal extension binds GTPase binding site/(tyrosine |
| | phosphorylation |
| Reference: | Aghazadeh, et al. (2000)⁷² |
| Protein: | CKI epsilon, casein kinase I epsilon |
| Inhibited activity: | Kinase |
| Inhibitory/activation: | C-terminal extension/phosphatase |
| Reference: | Cegielska et al. (1998)⁷³ |
| Protein: | GSK3beta, glycogen synthase kinase 3beta |
| Inhibited activity: | Kinase |
| Inhibitory/activation: | N-terminal phospho-pseudosubstrate/(inhibited by phosphorylation) |
| Reference: | Dajani et al. (2001)⁷⁴ |
| Protein: | MRCK, myotonic dystrophy kinase related Cdc42-binding |
| Inhibited activity: | Kinase |
| Inhibitory/activation: | Distal coiled-coil domain - binds kinase domain/phorbol ester |
| Reference: | Tan et al. (2001)⁶⁸ |
| Protein: | Pak1, (S. pombe)-p21- GTPase activated protein kinase, also MIHCK |
| Inhibited activity: | Kinase |
| Inhibitory/activation: | Regulatory domain/Cdc42 binding |
| Reference: | Brzeska et al. (2001), |
| | Tu & Wigler (1999)⁷⁵ |
| Protein: | PKA/PKG, cAMP- and cGMP-dependent kinases |
| Inhibited activity: | Kinase |
| Inhibitory/activation: | Pseudosubstrate/cAMP or cGMP |
| Reference: | Francis et al. (2002)⁷⁶ |
| Protein: | SNF1, protein kinase |
| Inhibited activity: | Kinase |
| Inhibitory/activation: | Regulatory domain binds catalytic domain/SNF4 binds in low glucose |
| Reference: | Jiang & Carlson (1997)⁷⁷ |
| Protein: | Ephb2 receptor, B1 binding receptor tyrosine kinase |
| Inhibited activity: | Kinase |
| Inhibitory/activation: | Juxtamembrane domain binds catalytic domain/phosphorylation |
| Reference: | Wybenga-Groot et al. (2001)⁷⁸ |
| Protein: | Cystathionine beta-synthase |
| Inhibited activity: | Condense homocysteine and serine in cysteine biosynthesis |
| Inhibitory/activation: | C-terminal domain/S-adenosyl-L-methionine binding |
| Reference: | Janosik et al. (2001)⁷⁹ |
| Protein: | Calcineurin, CN, protein phosphatase 2A |
| Inhibited activity: | Phosphatase |
| Inhibitory/activation: | N-terminal pseudosubstrate/calmodulin binding |
| Reference: | Tokoyoda et al. (2000)⁸⁰ |
| Protein: | NADP malate dehydrogenase |
| Inhibited activity: | Reduction of oxaloacetate to L-malate |
| Inhibitory/activation: | C-terminal disulfide bridge occludes active site/reduction of |
| | disulfide bond |
| Reference: | Krimm et al. (1999)⁸¹ |

SUBCELLULAR LOCALIZATION

| | |
|---|---|
| Protein: | NFAT1, nuclear factor of activated T-cells transcription factor |
| Inhibited activity: | Nuclear localization |
| Inhibitory/activation: | 13 phosphates constitute NES/dephosphorylation by |
| | calcineurin reveals NLS |
| Reference: | Okamura et al. (2000)⁸² |
| Protein: | Tubby, transcription factor |
| Inhibited activity: | Nuclear localization |
| Inhibitory/activation: | Intramembrane domain sequestration/proteolysis |
| Reference: | Santagata et al. (2001)⁸³ |
| Protein: | Importin alpha |
| Inhibited activity: | Nuclear localization signal binding |
| Inhibitory/activation: | IBB pseudoligand/NLS and/or importin beta |
| Reference: | Catimel et al. (2001), |
| | Kobe (1999)⁸⁴ |
| Protein: | Notch, transcription factor |
| Inhibited activity: | Nuclear localization |
| Inhibitory/activation: | Transmembrane domain anchor/binding of intracellular domain |
| | to DSL ligand stimulating intramembrane proteolysis |
| Reference: | Mumm & Kopan (2000)⁸⁵ |
| Protein: | Relish NF-κB, transcription factor |
| Inhibited activity: | Nuclear localization |
| Inhibitory/activation: | C terminus/proteolytic cleavage |
| Reference: | Stoven et al. (2000)⁸⁶ |

Using the disclosure provided herein, candidate molecules in a any given library of candidate molecules may be screened according to the method provided herein to identify specific allosteric inhibitors of any one or all of these allosterically autoinhibited proteins without an undue amount of trial and error. Selected candidate molecules may be further described as essentially free of activity for catalytically inhibiting the protein of interest.

A selected candidate allosteric inhibitor molecule will have no more than a de minimus inhibitory effect on the catalytic activity of an autoinhibited molecule of interest, as demonstrable in vitro for binding to a catalytic domain isolated from said autoinhibited molecule, or no more than about a 5-10% detectable inhibitory binding activity for binding said catalytic domain.

This screening method described herein is not related to the screen used to identify wiskostatin⁴⁰. Compounds identified by the method as presented herein, may, however, identify inhibitors that, like wiskostatin, stabilize the autoinhibited conformation of their target molecule.

To identify candidate compounds that target an allosteric domain, for example PID, of an autoinhibited protein, for example Pak, a screen for small molecules that can inhibit full-length Pak kinase activity but cannot inhibit the isolated catalytic domain, is presented. Counter-screening against active-site directed inhibitors is therefore an integral step of the method.

A luminescence-based assay for kinase activity is used based on measurement of residual ATP in the reaction following kinase-mediated ATP hydrolysis. Kinase reactions are incubated for 2 hours, at which time the addition of luciferase and luciferin stops the kinase reaction and utilizes residual ATP to convert luciferin to oxyluciferin with the accompanying emission of light. Intensity of the emitted light is linearly correlated with ATP concentration. Thus, inhibited reactions will produce a positive luminescent signal relative to control reactions due to the inhibition of ATP consumption. The assay requires minimal manipulation, is conducted in 384-well plates and is insensitive to fluorescence or absorptive properties of individual compounds which can complicate other types of assays.

A high quantity (tens of milligrams), of recombinant human Pak1 was expressed and purified (FIG. 6), sufficient to screen>100,000 compounds. The isolated kinase domain of Pak is prepared by limited chymotrypsin proteolysis of the full-length protein and is purified by conventional column purification. The isolated kinase domain was confirmed to be constitutively active and to not be stimulated by Cdc42.

### EXAMPLE 6

### Screening Method

The present example presents one embodiment of the screening method as it has been performed in screening for compounds having autoinhibitory (allosteric) activity for the kinase, p-21-activated kinase. A commercial library of compounds comprising over 30,000 structurally and functionally unrelated diverse chemical compounds was used as the library of candidate compounds employed in the present example. The particular commercial library of commercial molecules used was obtained from Chemical Diversity, Inc., and comprised about 30,000 diverse small molecules.

Sequence of Steps:

1. Pairs of 384-well plates are filled with either full-length Pak1 kinase or the isolated kinase domain.
2. Individual compounds are transferred into each well from compound stock plates to a final concentration of ˜6 μM and mixed using a polypropylene pin array.
3. The kinase reaction is initiated by the addition of recombinant Cdc42 (activated with the non-hydrolyzable GTP analogue GTPγS), ATP, and myelin basic protein (substrate) and the plates are incubated for 2 hours at 30° C.
4. Reactions were stopped by the addition of a luciferase/luciferin reagent (for example, a luciferase/luciferin reagent commercially available from Promega®) and luminescence is measured in a plate reader.

The following Table 2 provides the final concentrations of the reagents used in the assay:

TABLE 2

| | Volume | | |
|---|---|---|---|
| Reagent | (uL) | Concentration of Stock | Final Concentration |
| 1× Phospho Buffer | 10.575 | 2× (before use dilute 1:2) | ˜1× |
| WT Pak | 2 | 0.208 mg/mL (1:4 dil of 0.8 mg/mL stock) | 0.028 mg/mL = ˜450 nM |
| MBP (substrate) | 1.125 | 2 mg/mL | 0.15 mg/mL = ˜6 μM |
| Paktide (substrate) | 1 | 1.25 mg/mL (1:4 dilution of 10 mg/mL) | 83.34 ug/mL |
| Cdc42 | 1 | 20 uM (1:8 dilution of 160 uM frozen stock | 1.34 uM |
| ATP | 0.3 | 500 uM ATP | 10 uM |

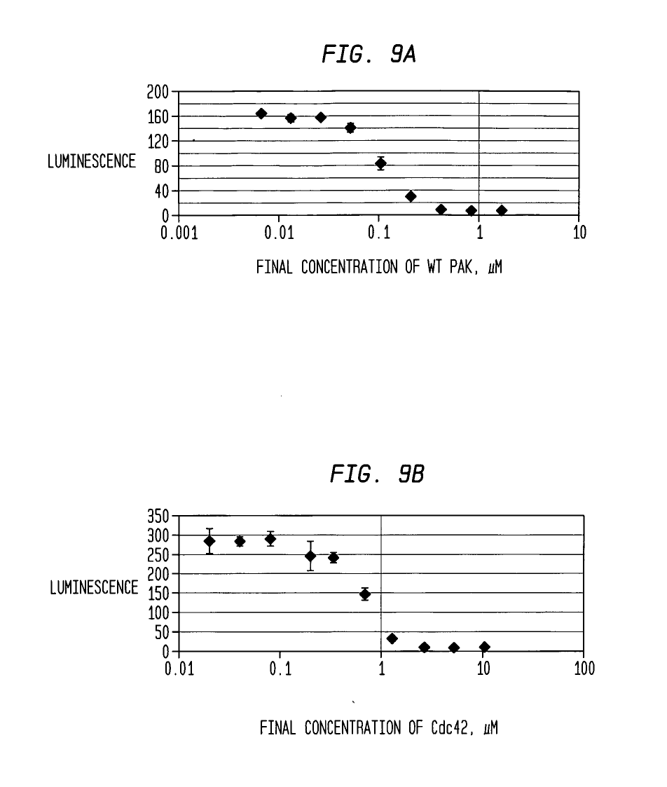

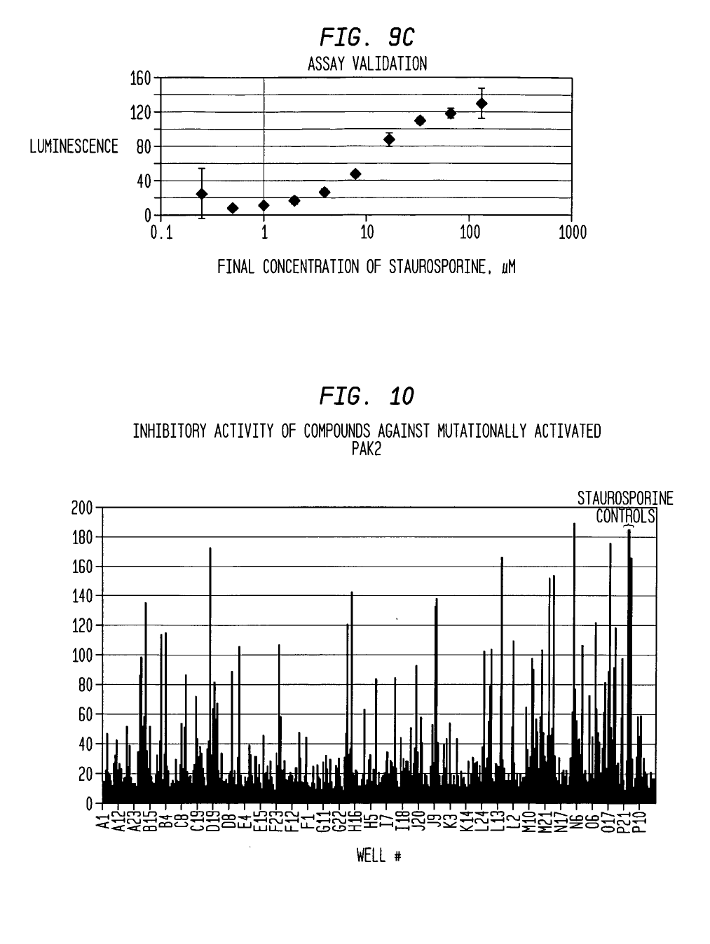

The assay was robust, acutely sensitive to Pak kinase activity, and was fully dependent on activation by Cdc42 (FIGS. 9A, 9B), thus recapitulating the physiological regulation of catalytic activity. Furthermore, using the broad-spectrum kinase inhibitor staurosporine, it is demonstrated here that the assay successfully detects inhibition of Pak by small molecules (FIG. 9C).

The library of about 30,000 small molecules described above were screened using this method for their ability to inhibit full length, wildtype Pak1. About 388 individual compounds were identified that inhibited the full length, wildtype Pak1 activity by at least 20% at the screening compound concentration of 6 μM. This group of molecules constituted the candidate pool of potential inhibitors that were further screened in the “second phase” of the screening protocol.

In the second phase of the screening protocol, the candidate pool of inhibitory compounds (e.g., the 388 compounds) is assayed for their ability to inhibit two constitutively active forms of Pak. These two constitutively active forms of Pak were:
a) an isolated catalytic domain prepared from the full length Pak1 by limited proteolysis, and
b) a mutationally activated allele of Pak2.

Active compounds, i.e., compounds that inhibit full-length, native molecules of interest (e.g., such as wild-type Pak), and that are unable to inhibit the activity of non-native forms of the autoinhibited molecule of interest (e.g., a constitutively active form, mutated form, and/or an isolated catalytic domain of Pak) by at least 20% at a screening concentration of about 10% μM, will be selected as specific autoinhibitory (allosteric) inhibitory compounds of the autoinhibited molecule, Pak.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

### BIBLIOGRAPHY

The following references are specifically incorporated herein in their entirety.
1. Hirokawa, Y., et al., (2004), Cancer J., 10(1): 20-6.
2. Kumar, R. and R. K. Vadlamudi, (2002), J. Cell Physiol., 193(2): 133-44.
3. Kissil, J. L., et al., (2003), Mol. Cell, 12(4): 841-9.
4. Leberer, E., et al., T. (1992), EMBO J., 11(13): 4815-24.
5. Ramer, S. W. and R. W. Davis, (1993), Proc. Nat'l. Acad. Sci. USA, 90(2): 452-6.
6. Cvrckova, F., et al., (1995), Genes Dev., 9(15): 1817-30.
7. Ottilie, S., et al., (1995), EMBO J., 14(23): 5908-19.
8. Marcus, S., et al., (1995), Proc. Nat'l Acad. Sci. USA, 92(13): 6180-4.
9. Manser, E., et al., (1997), Mol. Cell. Biol, 17(3): 1129-43.
10. Sawin, K. E., M. A. Hajibagheri, and P. Nurse, (1999), Curr. Biol., 9(22): 1335-8.
11. Sells, M. A., et al., (1997), Curr. Biol., 7(3): 202-10.
12. Sells, M. A., J. T. Boyd, and J. Chernoff, (1999), J. Cell Biol., 145(4): 837-49.
13. Kiosses, W. B., et al., (1999), J. Cell Biol., 147(4): 831-44.
14. Chung, C. Y. and R. A. Firtel, (1999), J. Cell Biol., 147(3): 559-76.
15. Allen, K. M., et al., (1998), Nat. Genet., 20(1): 25-30.
16. Daniels, R. H., et al. (1998), EMBO. J, 17(3): 754-64.
17. Melzig, J., et al. (1998), Curr. Biol., 8(22): 1223-6.
18. Hing, H., et al. (1999), Cell, 97(7): 853-63.
19. Newsome, T. P., et al. (2000), Cell, 101(3): 283-94.
20. Tang, Y., et al. (1997), Mol. Cell Biol., 17(8): 4454-64.
21. Tang, Y., et al., (1998), Proc. Nat'l Acad. Sci. USA, 95(9): 5139-44.
22. Tang, Y., J. Yu, and J. Field, (1999), Mol. Cell Biol., 19(3): 1881-91.
23. Carter, J. H., et al. (2004), Clin. Cancer Res., 10(10): 3448-56.
24. Schraml, P., et al. (2003), Am. J. Pathol., 2003. 163(3): 985-92.
25. Mira, J. P., et al. (2000), Proc. Nat'l. Acad. Sci. USA, 97(1): 185-9.
26. Lu, W., et al. (1997), Curr. Biol, 7(2): 85-94.
27. King, A. J., et al. (1998), Nature, 396(6707): 180-3.
28. Chaudhary, A., et al., (2000), Curr. Biol., 2000. 10(9): 551-4.
29. Tran, N. H. and J. A. Frost, (2003), J. Biol. Chem., 278(13): 11221-6.
30. Eblen, S. T., et al., (2002), Mol. Cell Biol., 22(17): 6023-33.
31. Slack-Davis, J. K., et al., (2003), J. Cell Biol., 162(2): 281-91.
32. Lei, M., et al., (2000), Cell, 102(3): 387-97.
33. Zhao, Z. S., et al., (1998), Cell Biol., 18(4): 2153-63.
34. Manser, E., et al., (1994), Nature, 367(6458): 40-6.
35. Kim, A. S., et al., (2000), Nature, 404(6774): 151-8.
36. DeDecker, B. S., (2000), Chem. Biol., 7(5): R103-7.
37. Takenawa, T. and H. Miki, (2001), J. Cell Sci., 114(Pt 10):1801-9.
38. Snapper, S. B. and F. S. Rosen, (1999), Annu. Rev. Immunol., 17: 905-29.
39. Peterson, J. R., et al. (2001), Proc. Nat.'l. Acad. Sci. USA, 98(19):10624-9.
40. Peterson, J. R., et al., (2004), Nat. Struct. Mol. Biol., 11(8): 747-55.
41. Jaffer, Z. M. and J. Chernoff (2002), Int. J. Biochem. Cell Biol., 34(7):713-7.
42. Ding, J., et al., (1996), J. Biol. Chem., 271(40): 24869-73.
43. Maroney, A. C., et al., (2001), J. Biol. Chem., 276 (27): 25302-8.
44. Nheu, T. V., et al., (2002), Cancer J, 8(4): 328-36.
45. Zenke, F. T., et al. (1999), J. Biol. Chem., 274 (46):32565-73.
46. United States Published Patent Application US 2005/0080002—Jacks et al.
47. Kim, A. S., et al. (2000), Nature, 404 (6774): 151-8.
48. Lei, M. et al. (2000), Cell, 102 (3): 387-397.
49. Chernoff, J., et al. (2003), Fox Chase Cancer Center Scientific Report, 2003.
50. Peterson, J. R. (2004), J. Cell Biochem., 93 (1): 68-73.
51. Ausubel, et al. (2000), In: Current Protocols in Molecular Biology, Chapter 9, John Wiley& Sons, New York.
52. Pufall and Graves, (2002), Ann. Rev. Cell Dev. Biol., 18:421-462.
53. Otomo T, Otomo C, Tomchick D R, Machius M, Rosen M K. (2005), Mol. Cell. 29: 18 (3):273-81.
54. Li F, Higgs H N. (2003), Curr. Biol., 5: 13(15):1335-40.
55. U.S. Published Patent Application—US 2004/0132634—Sicheri, et al.
56. Zhong et al. (1998) Mol. Cell, 1: 661-71.
57. Wang et al. (1999), J. Biol. Chem., 274: 19017-24.
58. Lefstin & Yamamoto (1998), Nature, 392:885-88.
59. Moir et al. (2002), J. Biol. Chem., 277: 694-701.
60. Mittal et al. (1999), Genes Dev., 13:1807-21.
61. Zhao & Herr (2002), Cell, 108: 615-27.
62. Chan et al. (1996), EMBO J., 15: 2476-87.
63. Brass et al. (1996), Genes Dev., 10: 2335-47.
64. Ko & Prives (1996), Genes Dev., 10: 1054-72.
65. Lin et al. (1999), Mol. Cell Biol., 19: 2465-74.
66. Yan et al. (2000), Mol. Cell Biol., 20: 661-71.
67. Fong & Zhou (2000), Mol. Cell Biol., 20: 5897-907.
68. Tan et al. (1999), J. Biol. Chem., 274:23687-90.
69. Johnson & Craig (2000), J. Biol. Chem., 275: 95-105.
70. Young & Gautel (2000), EMBO J., 19: 6331-40.
71. Rutter & Mcknight (2001), Proc. Natl. Acad. Sci. USA, 98: 8991-96.
72. Aghazadeh, et al. (2000), Cell, 102: 625-33.
73. Cegielska, et al. (1998), J. Biol. Chem., 273: 1357-64.
74. Dajani et al. (2001), Cell, 105: 721-32.
75. Tu & Wigler (1999), Mol. Cell Biol., 19: 602-11.
76. Francis et al. (2002), Front. Biosci., 7: D580-92.
77. Jiang & Carlson (1997), Mol. Cell Biol., 17: 2099-106.
78. Wybenga-Groot et al. (2001), Cell, 106: 745-57.
79. Janosik et al. (2001), Biochemistry, 40: 10625-33.
80. Tokoyoda et al. (2000), J. Biol. Chem., 275: 11728-34.
81. Krimm et al. (1999), J. Biol. Chem., 274:34539-42.
82. Okamura et al (2000), Mol. Cell, 6:539-50.
83. Santagata et al. (2001), Science, 292:2041-50.
84. Kobe (1999), Nat. Struct. Biol., 6:388-97.
85. Mumm & Kopan (2000), Dev. Biol., 228:151-65.
86. Stoven et al. (2000), EMBO Rep., 1: 347-52.
87. William P. Janzen, “High Throughput Screening Methods and Protocols”, (Humana Press), published April 2002. ISBN:0-89603-889-0.
88. Moshinsky, D. J., et al. (2003), In: J. Biomol. Screening, 8 (4): 447-452.

1. A method comprising screening a library of molecules to provide a pool of specific inhibitory compounds, said method comprising:
screening a library of compounds to provide a selected pool of inhibitory compounds capable of inhibiting a native form of an autoinhibited molecule of interest;
screening the selected pool of inhibitory compounds to identify compounds essentially free of inhibiting activity for a non-native form of the autoinhibited molecule of interest; and
selecting the compounds essentially free of inhibiting activity for the non-native form of the autoinhibited molecule of interest to provide a pool of specific inhibitory compounds.

2. The method of claim 1 comprising a luminescence-based method.

3. The method of claim 2 wherein the luminescence-based method provides a measure of kinase activity.

4. The method of claim 1 wherein the non-native form of the autoinhibited molecule of interest comprises a catalytic domain of the autoinhibited molecule.

5. The method of claim 1 wherein the non-native form of the autoinhibited molecule of interest comprises a mutant of the autoinhibited molecule.

6. The method of claim 5 wherein the mutant of the autoinhibited molecule is a deletion mutant or a substitution mutant of the autoinhibited molecule of interest.

7. The method of claim 1 wherein the non-native form of the autoinhibited molecule of interest is a constitutively active form of the autoinhibited molecule.

8. The method of claim 1 wherein the autoinhibited molecule of interest is a protein.

9. The method of claim 8 wherein the protein is a p-21-activated kinase.

10. The method of claim 8 wherein the non-native form of the autoinhibited molecule of interest is delta PH.

11. The method of claim 8 wherein the autoinhibited molecule of interest is Protein Kinase D.

12. The method of claim 1 wherein the autoinhibited molecule of interest is MLK3.

13. The method of claim 12 wherein the non-native form of the autoinhibited molecule of interest is pMLK3.

14. The method of claim 1 wherein the autoinhibited molecule of interest is a kinase.

15. The method of claim 1 wherein the autoinhibited molecule of interest is a non-kinase.

16. The method of claim 1 wherein the non-native form of the autoinhibited molecule of interest comprises Pak2.

17. A screening method for obtaining selective inhibitory compounds for an autoinhibited molecule of interest comprising:
screening a library of candidate compounds to obtain a pool of inhibitory compounds essentially free of activity for inhibiting a non-native form of the autoinhibited molecule of interest; and
screening said pool of inhibitory compounds for inhibitory activity of a native form of said autoinhibited molecule of interest to obtain selective inhibitory compounds,
wherein the selective inhibitory compounds are essentially free of inhibitory activity for the non-native form of the autoinhibited molecule of interest and posses inhibitory activity for the native form of the autoinhibited molecule of interest.

18. The screening method of claim 17 wherein the autoinhibited molecule of interest is a kinase.

19. The screening method of claim 18 wherein the non-native form of the autoinhibited molecule of interest is a mutant kinase.

20. The screening method of claim 18 having a Z′ value of at least 0.8.

21. A preparation enriched for a composition comprising an inhibitory compound specific for an autoinhibited molecule of interest, said composition being prepared by a method comprising:
screening a library of candidate compounds to obtain a pool of inhibitory compounds essentially free of activity for inhibiting a non-native form of the autoinhibited molecule of interest; and
screening said pool of inhibitory compounds for inhibitory activity for a native form of the autoinhibited molecule of interest to obtain a composition enriched for an inhibitory compound specific for the autoinhibited molecule of interest.

22. The preparation of claim 21 wherein the autoinhibited molecule of interest is a p-21-activated kinase (Pak).

23. A pharmaceutical preparation comprising the preparation of claim 21.

24. The method of claim 12 wherein the autoinhibited molecule of interest is a formin.

25. The method of claim 24 wherein the formin is mDia1.
